(19) United States
(12) Patent Application Publication
(10) Pub. No.: US 2025/0383778 A1
(43) Pub. Date: Dec. 18, 2025

(54) BUFFER MANAGEMENT TECHNIQUES FOR A MEMORY SYSTEM

(71) Applicant: Micron Technology, Inc., Boise, ID (US)

(72) Inventors: Nitul Gohain, Bangalore (IN); Jameer Mulani, Bangalore (IN); Prasad Bylahalli Chandrashekara, Bangalore (IN)

(21) Appl. No.: 19/229,966

(22) Filed: Jun. 5, 2025

Related U.S. Application Data
(60) Provisional application No. 63/659,445, filed on Jun. 13, 2024.

(51) Int. Cl. G06F 3/06

(52) U.S. Cl. CPC G06F 3/0613; G06F 3/0619; G06F 3/0656; G06F 3/0659; G06F 3/0673

(57) ABSTRACT

Methods, systems, and devices for buffer management techniques for a memory system are described. A memory system may store, in a buffer, a set of data for a parallel read operation that involves concurrently reading from a first die and from a second die, the set of data comprising first data and second data. The memory system may write the first data to a low-density portion of the first die based on writing the second data to the low-density portion of the first die and based on the second die being unavailable for writing the first data. The memory system may copy, based on the first data being included in the set of data for the parallel read operation, the first data from the low-density portion of the first die to a high-density portion of the second die.

### CROSS REFERENCE

The present Application for Patent claims priority to U.S. Patent Application No. 63/659,445 by Gohain et al., entitled “BUFFER MANAGEMENT TECHNIQUES FOR A MEMORY SYSTEM,” filed Jun. 13, 2024, which is assigned to the assignee hereof, and which is expressly incorporated by reference in its entirety herein.

### TECHNICAL FIELD

The following relates to one or more systems for memory, including buffer management techniques for a memory system.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states if disconnected from an external power source.

### BRIEF DESCRIPTION OF THE DRAWINGS

FIG. 1 shows an example of a system that supports buffer management techniques for a memory system in accordance with examples as disclosed herein.

FIG. 2 shows an example of a system that supports buffer management techniques for a memory system in accordance with examples as disclosed herein.

FIG. 3 shows an example of memory dies that support buffer management techniques for a memory system in accordance with examples as disclosed herein.

FIG. 4 shows an example of a process flow that supports buffer management techniques for a memory system in accordance with examples as disclosed herein.

FIG. 5 shows an example of a process flow that supports buffer management techniques for a memory system in accordance with examples as disclosed herein.

FIG. 6 shows a block diagram of a memory system that supports buffer management techniques in accordance with examples as disclosed herein.

FIG. 7 shows a flowchart illustrating a method or methods that support buffer management techniques for a memory system in accordance with examples as disclosed herein.

### DETAILED DESCRIPTION

A memory system may include a buffer that temporarily stores data such as data received from a host system (referred to as incoming data) that is for writing to the memory dies of the memory system. For performance purposes, the memory system may initially copy the data from the buffer to low-density portions of the memory dies, a process referred to as flushing the data, then later copy the data from the low-density portions to high-density portions of the memory dies, a process referred to as folding the data. To reduce the latency associated with retrieving stored data, it may be desirable for linked data (e.g., data associated with sequentially indexed logical addresses) to be distributed across the memory dies so that the linked data can be read using a parallel read operation in which data is read concurrently from multiple memory dies. Data that is distributed across memory dies in a manner that enables parallel reading may be referred to as “in-order” data.

In some examples, the memory system may be prevented from flushing data from the buffer because the destination memory die for flushing the data (which may be selected to enable parallel reading of the data) is unavailable for writing the data (e.g., due to a memory maintenance operation being performed by the die). In such examples, the rate of incoming data may outpace the rate at which the memory system can flush the buffered data such that the memory system is unable to accommodate (e.g., receive) new incoming data from the host system until the destination die is available for flushing. But waiting to receive new incoming data until the destination die is available for flushing may increase the latency of the memory system.

According to the techniques described herein, a memory system may improve latency by flushing linked data to memory dies in an out-of-order manner (e.g., a manner that does not enable parallel reading) if the memory system detects that a destination memory die for at least some of the linked data is unavailable. Such a technique may free up (e.g., make available for writing) the buffer space occupied by the linked data for additional incoming data even though the destination memory die is unavailable. During folding, the memory system may write the linked data to the high-density portions of the memory dies in-order (e.g., in a manner that supports parallel reading) so that the retrieval latency for the linked data is low even though the linked data was initially written out-of-order. Such a technique, referred to as the fold-focused technique, may be useful for managing the buffer in scenarios in which linked data is received sequentially (such that data associated with consecutive ranges of logical addresses are received in-sequence).

If linked data is received at the memory system non-sequentially (e.g., such that data associated with consecutive ranges of logical addresses are received out-of-sequence) and one or more conditions are satisfied, the memory system may use a flush-focused technique for managing the buffer. For example, if the rate of incoming data is below a threshold and the available buffer space is greater than a threshold, the memory system may hold (e.g., delay flushing) a first portion of linked data until a second portion of the linked data is buffered so that both portions of the linked data can be flushed in-order (rather than flushed out-of-order then folded in-order). In some examples, the memory system may implement aspects of both the fold-focused technique and the flush-focused technique.

In addition to applicability in memory systems as described herein, techniques for buffer management may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by improving memory access speeds), which may decrease processing or latency times, improve response times, or otherwise improve user experience, among other benefits.

In addition to applicability in memory systems as described herein, techniques for buffer management may be generally implemented to support increased connectivity of electronic systems. As the use of systems relying on interconnected electronic devices increases, the connectivity of these electronic devices becomes an increasingly relevant factor for the operations of the system. For example, delays associated with signals communicated between devices may become increasingly relevant as critical systems come to rely more on connectivity, as a system uses larger quantities of interconnected devices, or if the quantity and the complexity of signals communicated between devices increases. Implementing the techniques described herein may support techniques for increased connectivity in electronic systems by improving data transfer between devices, among other benefits.

Features of the disclosure are illustrated and described in the context of systems, devices, and circuits. Features of the disclosure are further illustrated and described in the context of process flows and flowcharts.

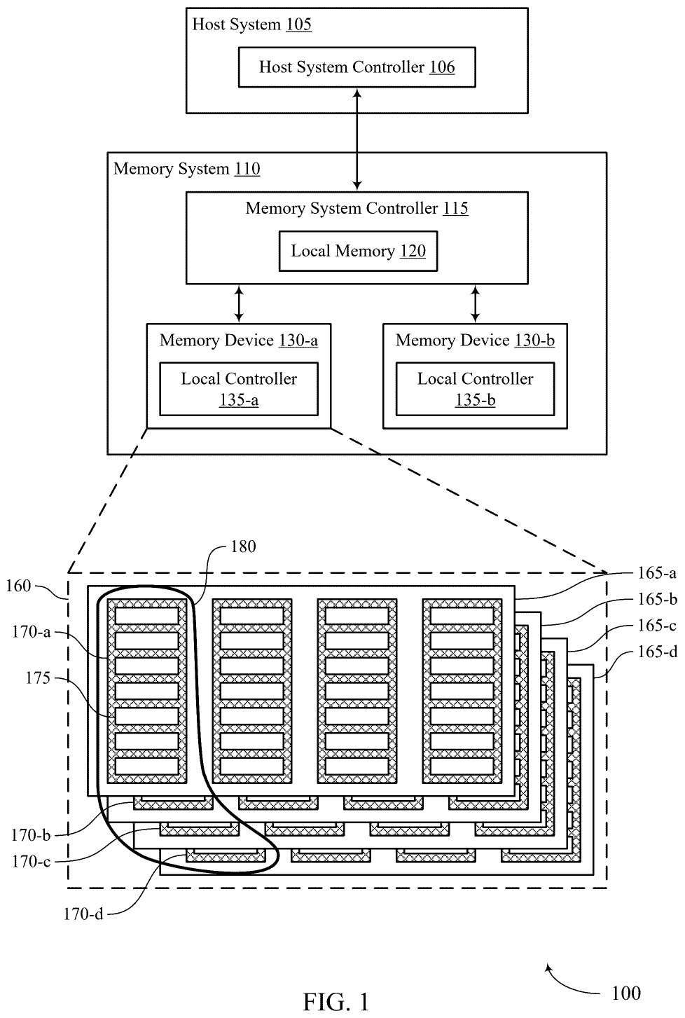

FIG. 1 shows an example of a system 100 that supports buffer management techniques for a memory system in accordance with examples as disclosed herein. The system 100 includes a host system 105 coupled with a memory system 110. The system 100 may be included in a computing device such as a desktop computer, a laptop computer, a network server, a mobile device, a vehicle, an Internet of Things (IOT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130-among other such operations-which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a buffer for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on the same die, within the same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

In some cases, to update some data within a block 170 while retaining other data within the block 170, the memory device 130 may copy the data to be retained to a new block 170 and write the updated data to one or more remaining pages of the new block 170. The memory device 130 (e.g., the local controller 135) or the memory system controller 115 may mark or otherwise designate the data that remains in the old block 170 as invalid or obsolete and may update a logical-to-physical (L2P) mapping table to associate the logical address (e.g., LBA) for the data with the new, valid block 170 rather than the old, invalid block 170. In some cases, such copying and remapping may be performed instead of erasing and rewriting the entire old block 170 due to latency or wearout considerations, for example. In some cases, one or more copies of an L2P mapping table may be stored within the memory cells of the memory device 130 (e.g., within one or more blocks 170 or planes 165) for use (e.g., reference and updating) by the local controller 135 or memory system controller 115.

In some cases, L2P mapping tables may be maintained and data may be marked as valid or invalid at the page level of granularity, and a page 175 may contain valid data, invalid data, or no data. Invalid data may be data that is outdated, which may be due to a more recent or updated version of the data being stored in a different page 175 of the memory device 130. Invalid data may have been previously programmed to the invalid page 175 but may no longer be associated with a valid logical address, such as a logical address referenced by the host system 105. Valid data may be the most recent version of such data being stored on the memory device 130. A page 175 that includes no data may be a page 175 that has never been written to or that has been erased.

In some cases, a memory system controller 115 or a local controller 135 may perform operations (e.g., as part of one or more media management algorithms) for a memory device 130, such as wear leveling, background refresh, garbage collection, scrub, block scans, health monitoring, or others, or any combination thereof. For example, within a memory device 130, a block 170 may have some pages 175 containing valid data and some pages 175 containing invalid data. To avoid waiting for all of the pages 175 in the block 170 to have invalid data in order to erase and reuse the block 170, an algorithm referred to as “garbage collection” may be invoked to allow the block 170 to be erased and released as a free block for subsequent write operations. Garbage collection may refer to a set of media management operations that include, for example, selecting a block 170 that contains valid and invalid data, selecting pages 175 in the block that contain valid data, copying the valid data from the selected pages 175 to new locations (e.g., free pages 175 in another block 170), marking the data in the previously selected pages 175 as invalid, and erasing the selected block 170. As a result, the quantity of blocks 170 that have been erased may be increased such that more blocks 170 are available to store subsequent data (e.g., data subsequently received from the host system 105).

In some cases, a memory system 110 may utilize a memory system controller 115 to provide a managed memory system that may include, for example, one or more memory arrays and related circuitry combined with a local (e.g., on-die or in-package) controller (e.g., local controller 135). An example of a managed memory system is a managed NAND (MNAND) system.

In some examples, the fold-focused buffer management technique may be implemented if the linked data is received sequentially (e.g., in an ordered manner such that data associated with consecutive ranges of logical addresses are received in-sequence). To illustrate, if the linked data includes first data associated with logical addresses L0-L3, second data associated with logical addresses L4-L7, and third data associated with logical addresses L8-L11, the linked data is referred to as being received sequentially if the second data is received after the first data and before the third data. Put another way, linked data may be referred to as being received sequentially if a portion of the linked data associated with lower-indexed logical addresses is received before a portion of the linked data associated with higher-indexed logical addresses, where a first logical address is lower-indexed relative to a second logical address if it is closer to zero than a second logical address.

In some examples, the memory system 110 may (e.g., via the memory system controller 115) additionally or alternatively manage the buffer by implementing the flush-focused technique as described herein. For example, the flush-focused technique may be implemented if the linked data is received non-sequentially (e.g., in a disordered manner such that data associated with consecutive ranges of logical addresses are received out-of-sequence). To illustrate, if the linked data includes first data associated with logical addresses L0-L3, second data associated with logical addresses L4-L7, and third data associated with logical addresses L8-L11, the linked data is referred to as being received non-sequentially if the second data is not received after the first data and before the third data. Put another way, linked data may be referred to as being received non-sequentially if a portion of the linked data associated with lower-indexed logical addresses is received after a portion of the linked data associated with higher-indexed logical addresses.

In the flush-focused technique, if the memory system 110 detects that a portion of linked data has been received non-sequentially, the memory system 110 may delay flushing the portion of linked data until the remaining linked data has been received (e.g., so that the linked data can be written in-order during flushing).

The system 100 may include any quantity of non-transitory computer readable media that support buffer management techniques for a memory system. For example, the host system 105 (e.g., a host system controller 106), the memory system 110 (e.g., a memory system controller 115), or a memory device 130 (e.g., a local controller 135), or any combination thereof may include or otherwise may access one or more non-transitory computer readable media storing instructions (e.g., firmware, logic, code) for performing the functions ascribed herein to the host system 105, the memory system 110, or the memory device 130, or combination thereof. For example, such instructions, if executed by the host system 105 (e.g., by a host system controller 106), by the memory system 110 (e.g., by a memory system controller 115), or by a memory device 130 (e.g., by a local controller 135), may cause the host system 105, the memory system 110, or the memory device 130 to perform associated functions as described herein.

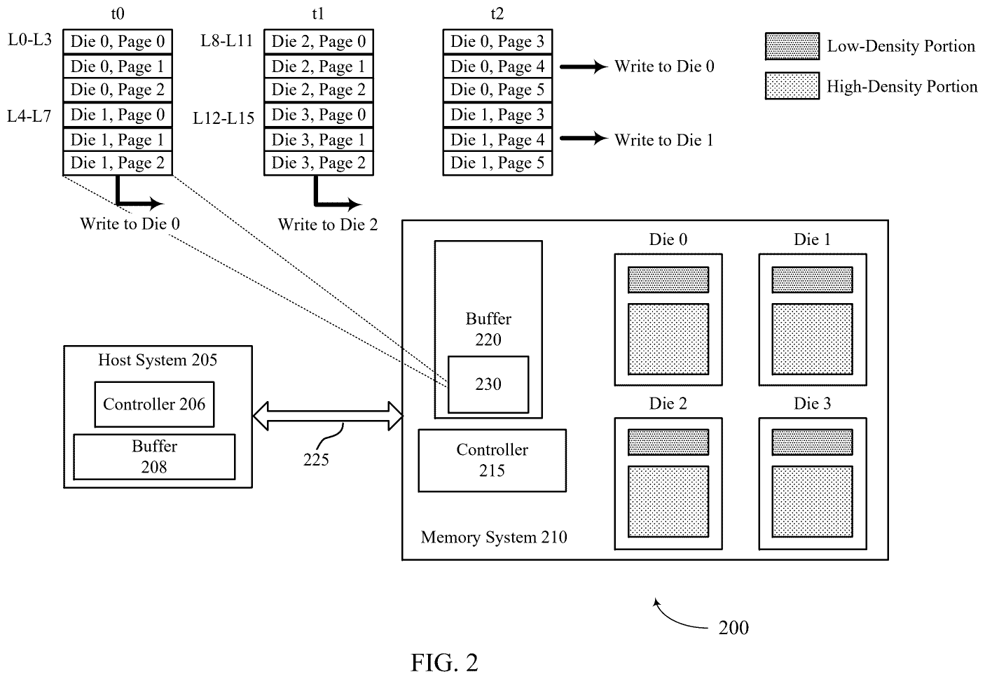

FIG. 2 shows an example of a system 200 that supports buffer management techniques for a memory system in accordance with examples as disclosed herein. The system 200 may be an example of a system 100 as described with reference to FIG. 1, or aspects thereof. The system 200 may include a memory system 210 configured to store data received from the host system 205 and to send data to the host system 205, if requested by the host system 205 using access commands (e.g., read commands, write commands). The system 200 may implement aspects of the system 100 as described with reference to FIG. 1. For example, the memory system 210 and the host system 205 may be examples of the memory system 110 and the host system 105, respectively. The memory system 210 may communicate (e.g., transmit and receive electronic signals representative of data and commands) with the host system 205 using the interface 225.

The host system 205 may include one or more controller(s) 206 for controlling the operations of the host system 205. In some examples, the controller(s) 206 may be an example of the host system controller 106 as described with reference to FIG. 1. The host system 205 may also include a buffer 208 (e.g., a volatile memory) that is configured to store data transferred between the memory system 210 and the host system 205. For example, the buffer 208 may be configured to temporarily store data for writing to the memory system 210 (e.g., data pending for transmission to the memory system 210), data read from the memory system 210 (e.g., data received from the memory system 210), or both.

The memory system 210 may include one or more memory dies (e.g., non-volatile memory dies) to store data transferred between the memory system 210 and the host system 205 (e.g., in response to receiving access commands from the host system 205). For example, the memory system 210 may include four memory dies: die 0, die 1, die 2, and die 3. Other quantities of memory dies are contemplated and within the scope of the present disclosure. The memory dies may be included in one or more memory devices as described with reference to FIG. 1. The memory system 210 may include one or more local controllers (e.g., similar to local controllers 135) for controlling the passing of data to and from the memory dies (e.g., for storing data, for retrieving data, for determining memory locations in which to store data and from which to retrieve data). The memory system 210 also may include a memory system controller 215 for executing the commands received from the host system 205, which may include controlling the data path components for the moving of the data. The memory system controller 215 may be an example of the memory system controller 115 as described with reference to FIG. 1.

The memory system 210 may support parallel read operations in which multiple memory dies are read concurrently (e.g., at partially or wholly overlapping times). For example, a parallel read operation may involve concurrently reading die 0, die 1, die 2, and die 3, provided that (e.g., conditioned on) the physical addresses being accessed share the page address (e.g., physical address) and block address (e.g., provided that the page address and block address being read in each die is the same across the dies). For example, a parallel read operation may be performed on (page 0, block 0) in die 0, (page 0, block 0) in die 1, (page 0, block 0) in die 2, and (page 0, block 0) in die 3. So, data stored at different memory dies but with the same physical address (e.g., page address, block address) may be read using a parallel read operation and may be referred to as being stored in-order.

The memory system 210 may store one or more L2P tables in the memory dies and may load L2P information from the tables into the buffer 220 for address translation. Address translation may refer to the process of translating (e.g., mapping) a logical address to a physical address. A logical address may be assigned to a set of data whereas a physical address may be assigned to a physical portion of memory. So, among other information, the L2P information for a set of data may indicate the logical address assigned to the set of data and the physical address where the set of data is stored in memory. In some examples, the L2P information for a set of data may be referred to as a metadata for the set of data.

The memory system 210 may perform various types of memory maintenance operations to organize data stored at the memory system and improve performance of the memory system 210. For example, to condense valid data and free up blocks for writing new data, the memory system 210 may perform a block maintenance operation, also referred to as a garbage collection operation, in which in which the memory system copies valid data from one or more source block(s) to one or more target block(s), and prepares (e.g., erases) the source block(s) for writing.

Data folding (e.g., copying data from low-density memory cells to high-density memory cells) may be another example of a type of memory maintenance operation performed by the memory system 210. Low-density memory cells may refer to memory cells that are in a low-density portion of a memory die, and a low-density portion may be a portion that is configured or reserved for a first type of write operation (e.g., an SLC write operation, a TLC write operation) associated with a first quantity of levels. An SLC write operation may refer to a write operation that is associated with two levels and that writes one bit per memory cell, whereas a TLC write operation may refer to a write operation that is associated with eight levels and that writes three bits per memory cell. High-density memory cells may refer to memory cells that are in a high-density portion of a memory die, and a high-density portion may be a portion that is configured or reserved for a second type of write operation (e.g., a QLC write operation) associated with a second quantity of levels greater than the first quantity of levels. A QLC write operation may refer to a write operation that is associated with sixteen levels and that writes four bits per memory cell.

Low-density memory cells may be accessed (e.g., written to, read from) faster than high-density memory cells and may be more reliable (e.g., less prone to errors) than high-density memory cells. However, high-density memory cells may (compared to low-density memory cells) reduce the amount of memory space consumed by data. Flushing data to low-density memory cells may allow the memory system 210 to (initially) store the data reliably and quickly, and folding the data to high-density memory cells may allow the memory system 210 to compact the data into fewer memory cells.

The memory system 210 may include a buffer 220 that stores incoming data (e.g., data for writing to the memory dies) from the host system 205 and outgoing data (e.g., data read from the memory dies) for the host system 205. In some examples, the buffer 220 may include a portion 230 that is reserved for incoming data. The buffer 220 may also store information such as L2P information that the memory system uses for address translation. The amount of data the memory system 210 can accept from the host system 205 may be proportional to the amount of memory space in the buffer 220 (e.g., the amount of memory space in portion 230) that is available for incoming data, where memory space is referred to as being available for incoming data if the memory space is unwritten or written with data that has already been written to the memory dies. If the memory system 210 runs out of available memory space in the buffer 220 for incoming data, the memory system 210 may pause the incoming data until more memory space in the buffer 220 becomes available for incoming data. But pausing incoming data may negatively impact the performance of the memory system 210.

In some examples, the memory system 210 may implement the fold-focused technique described herein to avoid pausing incoming data. For example, upon detecting that the destination die for a subset of a set of linked data is unavailable for writing the subset, the memory system 210 may flush the subset to a different die such that the linked data is written out-of-order to the low-density portions of the memory dies. Thus, the memory space in the buffer 220 occupied by the subset may be made available for new incoming data. Later (e.g., after the destination die has become available for writing the subset), the memory system 210 may fold the subset to the destination die so that the linked data is written in-order to the high-density portions of the memory dies.

To illustrate the folding-focused technique, a set of linked data is considered. The linked data may include first data associated with logical addresses L0-L3 (e.g., a first range of consecutively indexed logical addresses), second data associated with logical addresses L4-L7 (e.g., a second range of consecutively indexed logical addresses), third data associated with logical addresses L8-L11 (e.g., a third range of consecutively indexed logical addresses), and fourth data associated with logical addresses L12-L15 (e.g., a fourth range of consecutively indexed logical addresses). Logical address L4 may be said to be sequentially indexed relative to logical address L3, logical address L8 may be said to be sequentially indexed relative to logical address L7, and logical address L12 may be said to be sequentially indexed relative to logical address L11.

In some examples, the memory system 210 may identify linked data based on (e.g., due to) the linked data being associated with the same write command. For example, the memory system 210 may identify linked data as data associated with a set of logical addresses identified by a write command. In some, the memory system 210 may identify data as linked data based on the logical addresses associated with the data. For example, the memory system 210 may identify first data and second data as being included in a set of linked data based on (e.g., due to) the first data being associated with a first logical address (e.g., L4) that is sequentially indexed relative to a second logical address (e.g., L3) associated with the second data.

At time t0, the data in the buffer 220 may include the first data and the second data of the linked data. Although writing the first data and the second data in-order may involve writing the first data to die 0 (e.g., page 0) and the second data to die 1 (e.g., page 0), the destination die for the second data (e.g., die 1) may be unavailable for writing the second data. For example, die 1 may be in the midst of a garbage collection operation and thus unable to write new data such as the second data. In response to detecting that die 1 is unavailable for writing the second data, the memory system 210 may instead write the second data to die 0 (e.g., to the low-density portion of die 0), which may be available for writing new data. Thus, the memory space occupied by the second data may be made available for new incoming data even though the destination die for the second data is unavailable for writing the second data. The memory system 210 may also write the first data to die 0 (e.g., to the low-density portion of die 0). Thus, the first data and the second data of the linked data may be flushed out-of-order.

At time t1, the data in the buffer 220 may include the third data and the fourth data of the linked data (e.g., because the first data and the second data have been written to the memory dies thereby freeing up the memory space previously occupied in the buffer 220). Although writing the third data and the fourth data in-order may involve writing the third data to die 2 (e.g., page 0) and the second data to die 3 (e.g., page 0), the destination die for the fourth data (e.g., die 3) may be unavailable for writing the fourth data. For example, die 3 may be in the midst of a garbage collection operation and thus unable to write new data such as the fourth data. In response to detecting that die 3 is unavailable for writing the fourth data, the memory system 210 may instead write the fourth data to die 2 (e.g., to the low-density portion of die 2), which may be available for writing new data. Thus, the memory space occupied by the fourth data may be made available for new incoming data even though the destination die for the fourth data is unavailable for writing the fourth data. The memory system 210 may also write the third data to die 2 (e.g., to the low-density portion of die 2). Thus, the third data and the fourth data of the linked data may be flushed out-of-order.

At time t3, the data in the buffer 220 may include additional data for die 0 and die 1 (e.g., because the third data and the fourth data have been written to the memory dies thereby freeing up the memory space previously occupied in the buffer 220). By this time, die 1 may be available for writing new data. So, the memory system 210 may write the additional data for die 0 to the low-density portion of die 0 and may write the additional data for die 1 to the low density portion of die 1.

So, after flushing the linked data, the linked data may be stored out-of-order in the low-density portions of the memory dies. To enable a parallel read operation for the linked data, the memory system 210 may re-order the linked data during a flush operation so that the data is written in-order to the high-density portions of the memory dies. For example, the first data written to the low-density portion of die 0 may be written to the high-density portion of die 0 and the second data written to the low-density portion of die 0 may be written to the high-density portion of die 1. Similarly, the third data written to the low-density portion of die 2 may be written to the high-density portion of die 0 and the fourth data written to the low-density portion of die 2 may be written to the high-density portion of die 3. Thus, folding may involve copying some of the linked data to a different die than the data was flushed. To enable a parallel read operation, the linked data may be written to the same physical address across the memory dies. For example, the first data may be written to (page 0, block 0) in die 0, the second data may be written to (page 0, block 0) in die 1, the third data may be written to (page 0, block 0) in die 2, and the fourth data may be written to (page 0, block 0) in die 3.

Thus, the memory system 210 may manage the buffer 220 using the fold-focused technique. Additionally or alternatively, the memory system 210 may manage the buffer using the flush-focused technique.

In the flush-focused technique, the memory system 210 may determine that linked data has been received non-sequentially. For example, if the linked data includes first data associated with logical addresses L16-L19, second data associated with logical addresses L20-L23, and third data associated with logical addresses L24-L27, the memory system 210 may determine that the linked data has been received non-sequentially based on (e.g., in response to) determining that the first data and the third data have been received but the second data has not yet been received. In such a scenario, the memory system 210 may delay flushing of the first data and the third data until the second data has been received. In this way, the memory system 210 can flush the linked data in-order even though the linked data was received out-of-sequence. For example, the memory system 210 may write the first data to (page x, block y) of die 0, may write the second data to (page x, block y) of die 1, and may write the third data to (page x, block y) of die 2.

The memory system 210 may condition use of the flush-focused technique on the satisfaction of one or more thresholds. For example, the memory system 210 may implement the flush-focused technique if the rate of the incoming data is below a threshold, if the memory space available for writing incoming data is greater than a threshold, or both. Such conditioning of the flush-focused technique may ensure that implementation of the flush-focused technique does not unduly increase latency of the memory system 210.

The memory system 210 may use metadata to implement the buffer management techniques described herein. For example, the memory system 210 may add one or more metadata bits to the L2P information associated with linked data so that the memory system can implement the flush-focused technique, the fold-focused technique, or both, for that linked data. In some examples (e.g., in the flush-focused technique), the metadata bits may indicate portions of linked data that the memory system 210 is to delay flushing. In some examples the metadata bits may indicate an identifier for a set of linked data (e.g., so that the memory system 210 can identify linked data that is to be folded in-order).

The memory system 210 and the host system 205 may exchange signaling (e.g., via the interface 225) that supports implementation of the buffer management techniques described herein. In some examples, the memory system 210 may send to the host system 205 a capability message that indicates a data-handling capability of the memory system 210 (e.g., a capability to handle non-sequential linked data). In some examples, the host system 205 may send to the memory system 210 (e.g., responsive to the capability message) a message that activates a data-handling capability of the memory system 210, that indicates one or more buffer management techniques the memory system 210 is to implement, or both.

Thus, the memory system 210 may implements aspects of the buffer management techniques described herein.

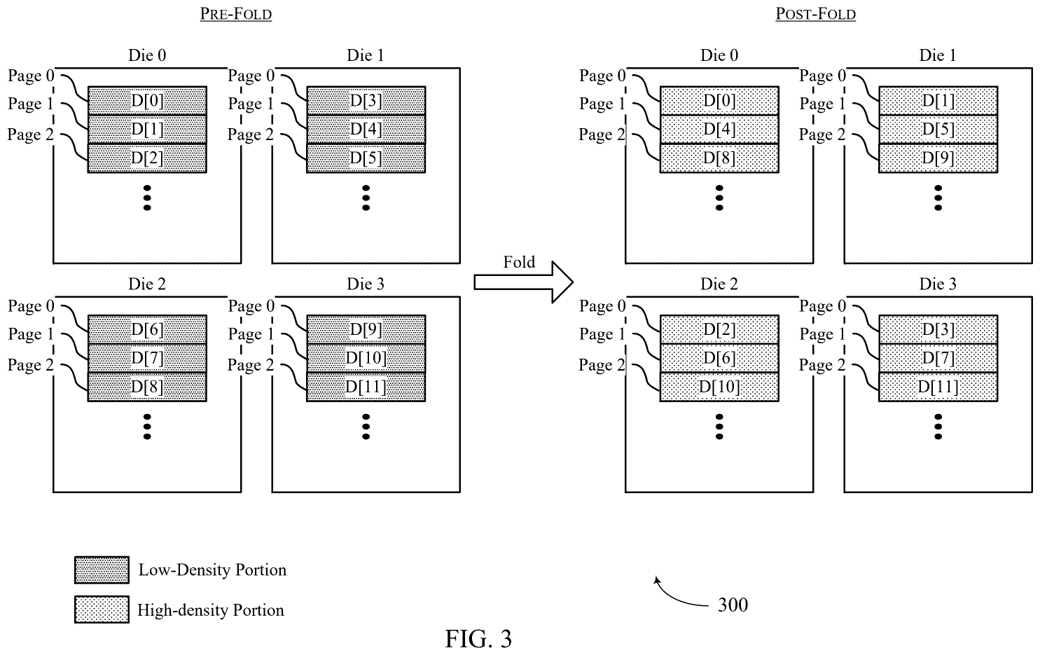

FIG. 3 shows an example of memory dies 300 that support buffer management techniques for a memory system in accordance with examples as disclosed herein. The memory dies 300 may be included in a memory system as described herein and may be examples of memory dies described with reference to FIGS. 1 and 2. The memory dies 300 may include die 0, die 1, die 2, and die 3. Other quantities of memory dies are contemplated and within the scope of the present disclosure. FIG. 3 illustrates the content of the memory dies 300 before a folding operation (denoted “pre-fold”) and after the folding operation (denoted “post-fold”). The folding operation may be implemented as part of the fold-focused technique described herein.

The memory dies 300 may store data denoted D[0] through D[11]. The data may include a first set of linked data, referred to as linked data, denoted D[0], D[1], D[2], and D[3]. Data D[0] may be referred to as first data, data D[1] may be referred to as second data, data D[2] may be referred to as third data, and data D[3] may be referred to as fourth data. In some examples, the first data D[0] may be associated with a first set of logical addresses (e.g., L0-L3), the second data D[1] may be associated with a second set of logical addresses (e.g., L4-L7), the third data D[2] may be associated with a third set of logical addresses (e.g., L8-L11), and fourth data D[3] may be associated with a fourth set of logical addresses (e.g., L12-L15). Thus, the linked data may be associated with contiguous sets of contiguous (e.g., sequentially indexed) logical addresses. In some examples, the data may include a second set

of linked data (e.g., D[4]-[D[7]), a third set of linked data (e.g., D8-D[11]), or both. In some examples, D[4]-D[7] may be included in the first set of linked data (e.g., the first set of linked

data may span D[0]-D[7]). In some examples, D[8]-D[11] may be included in the first set of linked data (e.g., the first set of linked data may span D[0]-D[7]).

Before the fold operation, the data (including the linked data) may be stored in the low-density portions of the memory dies 300. The linked data may be stored in the memory dies 300 out-of-order due to being flushed out-of-order as part of the fold-focused technique. For example, the first data D[0] may be stored in (page 0, block 0) of the low-density portion of die 0, the second data D[1] may be stored in (page 1, block 0) of the low-density portion of die 0, the third data D[2] may be stored in (page 2, block 0) of the low-density portion of die 0, and the fourth data D[3] may be stored in (page 0, block 0) of the low-density portion of die 3. So, before the fold operation the linked data may not be stored in a manner that supports a parallel read operation that involves concurrently reading data from the same physical address across different dies.

As part of the fold operation, the memory system may copy the data from the low-density portions of the memory dies 300 to the high-density portions of the memory dies. In doing so, the memory system may write the linked data in-order. For example, the memory system may: read the first data D[0] from the low-density portion of die 0 and write the first data D[0] to (page 0, block 0) of the high-density portion of die 0; read the second data D[1] from the low-density portion of die 0 and write the second data D[1] to (page 0, block 0) of the high-density portion of die 1; read the third data D[2] from the low-density portion of die 0 and write the third data D[2] to (page 0, block 0) of the high-density portion of die 2; and read the fourth data D[3] from the low-density portion of die 0 and write the fourth data D[3] to (page 0, block 0) of the high-density portion of die 4. So, after the fold operation the linked data may be stored in a manner that supports a parallel read operation that involves concurrently reading data from the same physical address (e.g., page 0, block 0) across different dies.

Thus, the memory system may implement the fold-focused technique described herein to write linked data in-order to the memory dies 300.

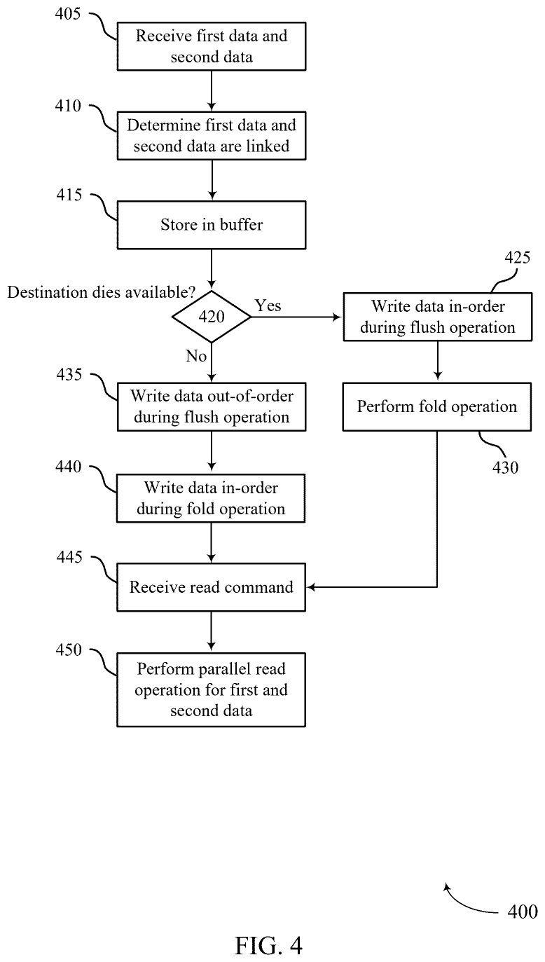

FIG. 4 shows an example of a process flow 400 that supports buffer management techniques for a memory system in accordance with examples as disclosed herein. The process flow 400 may be implemented by a system such as a memory system, which may be an example of a memory system 110 or a memory system 210 as described herein. The process flow 400 may include operations performed by the memory system as part of the fold-focused technique for buffer management.

Aspects of the process flow 400 may be implemented by one or more controllers, among other components. Additionally, or alternatively, aspects of the process flow 400 may be implemented as instructions stored in one or more memories (e.g., firmware stored in one or more memories coupled with the memory system 110, firmware stored in one or more memories coupled with the memory system 210). For example, the instructions, if executed by one or more controllers (e.g., the memory system controller 115, a local controller 135, the controller 215), may cause the one or more controllers (or a device or a system) to perform the operations of the process flow 400.

At 405, first data and second data may be received (e.g., at a memory system). The first data and the second data may be received from a host system and may be for writing to the memory media (e.g., non-volatile memory dies) of the memory system. The first data and the second data may be received concurrently or at different times. At 410, it may be determined (e.g., by the memory system) that the first data and the second data are included in a set of linked data that is for (e.g., assigned to, expected to be read using) a parallel read operation. In some examples, the memory system may determine that the first data and the second data are included in the set of linked data due to the first data and the second data being associated with (e.g., indicated by) the same write command. In some examples, the memory system may determine that the first data and the second data are included in the set of linked data due to the first data and the second data being associated with consecutive (e.g., sequentially indexed) ranges of logical addresses.

At 415, the first data and the second data may be stored (e.g., written) in a buffer of the memory system. The first data and the second data may be written to the buffer concurrently or at different times.

At 420, it may be determined (e.g., by the memory system) whether the destination dies for the first data and the second data are available for writing the first data and the second data, respectively. For example, the memory system may determine whether a first die (e.g., die 0) designated as the destination die for the first data is available for writing the first data. And the memory system may determine whether a second die (e.g., die 1) designated as the destination die for the second data is available for writing the second data. The destination dies for the first data and the second data may be selected based on (e.g., responsive to) the first data and the second data being linked. In some examples, the memory system may determine that a destination die is unavailable based on (e.g., due to) the destination die being in the midst of performing a memory maintenance operation.

If, at 420, it is determined that a destination die (e.g., die 1) is unavailable, the memory system may, at 435, write the first data and the second data out-of-order during a flush operation for the buffer. For example, the memory system may write the first data to a low-density portion of die 0 and may write the second data to the low-density portion of die 0 based on (e.g., due to) die 0 being available for writing. The first data and the second data may be written to different physical addresses on die 0 and die 1. At 440, the first data and the second data may be written (e.g., by the memory system) in-order during a fold operation. For example, the memory system may write the first data to a high-density portion of die 0 and may write the second data to a high-density portion of die 1. The memory system may write the first data and the second data in-order based on (e.g., due to) the first data and the second data being linked for a parallel read operation. Writing the first data and the second data in-order may include writing the first data and the second data to the same physical address (e.g., the same page address, the same block address) on die 0 and die 1.

If, at 420, it is determined that the destination dies are available, the memory system may, at 425, write the first data and the second data in-of-order during a flush operation for the buffer. At 430, a fold operation that maintains the first data and the second data in-order may be performed (e.g., by the memory system).

At 445, a read command for the first data and the second data may be received (e.g., by the memory system). In response to the read command, the memory system may, at 450, perform a parallel read operation for the first data and the second data. For instance, the memory system may concurrently read the first data from die 0 and the second data from die 1.

Thus, a memory system may implement the fold-focused buffer management technique as described herein. Alternative examples of the foregoing may be implemented, where some operations are performed in a different order than described, are performed in parallel, or are not performed at all. In some cases, operations may include additional features not mentioned herein, or further operations may be added. Additionally, certain operations may be performed multiple times or certain combinations of operations may repeat or cycle.

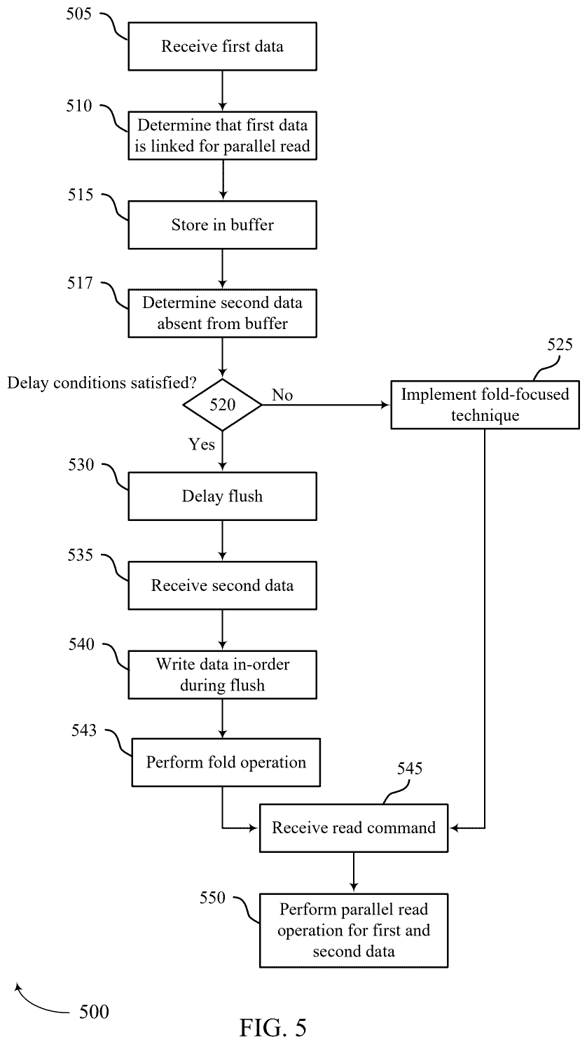

FIG. 5 shows an example of a process flow 500 that supports buffer management techniques for a memory system in accordance with examples as disclosed herein. The process flow 500 may be implemented by a system such as a memory system, which may be an example of a memory system 110 or a memory system 210 as described herein. The process flow 500 may include operations performed by the memory system as part of the flush-focused technique for buffer management.

Aspects of the process flow 500 may be implemented by one or more controllers, among other components. Additionally, or alternatively, aspects of the process flow 500 may be implemented as instructions stored in one or more memories (e.g., firmware stored in one or more memories coupled with the memory system 110, firmware stored in one or more memories coupled with the memory system 210). For example, the instructions, if executed by one or more controllers (e.g., the memory system controller 115, a local controller 135, the controller 215), may cause the one or more controllers (or a device or a system) to perform the operations of the process flow 500.

At 505, first data may be received (e.g., by the memory system). The first data may be received from a host system and may be for writing to the memory media (e.g., non-volatile memory dies) of the memory system. At 510, it may be determined (e.g., by the memory system) that a set of linked data for (e.g., assigned to, expected to be read using) a parallel read operation includes the first data and second data. In some examples, the memory system may determine that the first data and the second data are included in the set of linked data based on (e.g., due to) the first data and the second data being associated with (e.g., assigned to) consecutive (e.g., sequentially indexed) ranges of logical addresses. For instance, the first-indexed logical address associated with the second data may be sequential to the last-indexed logical address associated with the first data.

At 515, the first data may be stored (e.g., written) in a buffer of the memory system. At 517, it may be determined (e.g., by the memory system) that the second data included in the set of linked data is absent from the buffer (e.g., has not yet been received).

At 520, it may be determined (e.g., by the memory system) whether one or more conditions for delaying a flush operation for the first data is satisfied. For example, the memory system may determine whether a data rate of data received from the host system satisfies (e.g., is less than) a threshold. As another example, the memory system may determine whether an amount of buffer space available for writing incoming data satisfies a threshold. In some examples, the memory system may make the determination at 520 based on (e.g., responsive to) the determination at 517. If, at 520, it is determined that the condition(s) for delaying the flush operation are not satisfied, the memory system may, at 525, implement the fold-focused technique.

If, at 520, it is determined that the condition(s) for delaying the flush operation are satisfied, the memory system may, at 530 delay flushing the first data from the buffer. The memory system may delay the flush operation for the first data for a threshold amount of time or until a flush condition (e.g., receipt of the second data) is satisfied. At 535, the second data may be received (e.g., at the memory system). The second data may be received from the host system and may be for writing to the memory media (e.g., non-volatile memory dies) of the memory system. At 540, a flush operation for the set of linked data may be performed (e.g., by the memory system). As part of the flush operation, the memory system may write the set of linked data in-order (e.g., to the low-density portions of the memory dies). For instance, the memory system may write the first data and the second data to a same first physical address in die 0 and die 1, respectively.

At 543, a fold operation that maintains the first data and the second data in-order may be performed (e.g., by the memory system). For instance, the memory system may write the first data and the second data to same second physical address in high-density portions of die 0 and die 1, respectively. At 545, a read command for the first data and the second data may be received (e.g., by the memory system). In response to the read command, the memory system may, at 550, perform a parallel read operation for the first data and the second data. For instance, the memory system may concurrently read the first data from die 0 and the second data from die 1.

Thus, a memory system may implement the flush-focused management technique as described herein. Alternative examples of the foregoing may be implemented, where some operations are performed in a different order than described, are performed in parallel, or are not performed at all. In some cases, operations may include additional features not mentioned herein, or further operations may be added. Additionally, certain operations may be performed multiple times or certain combinations of operations may repeat or cycle.

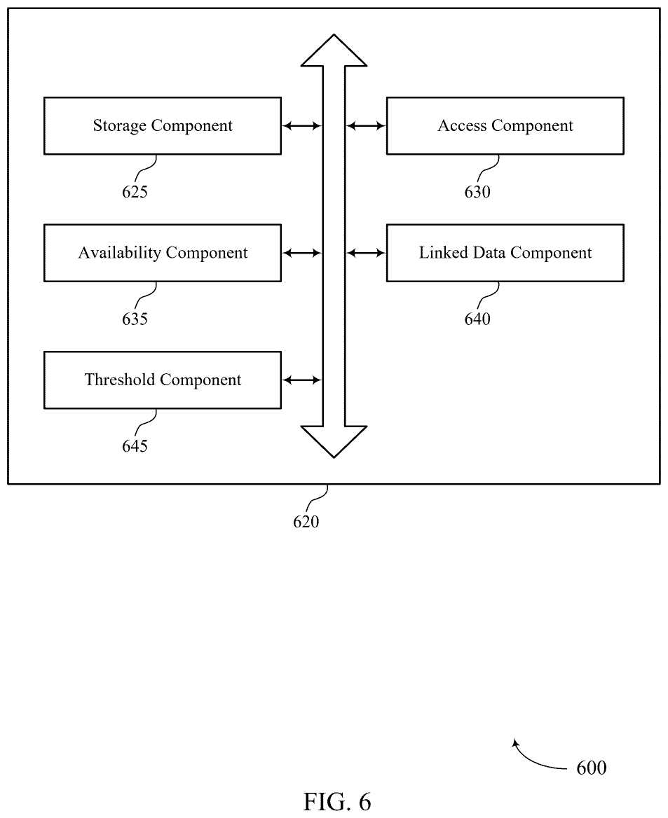

FIG. 6 shows a block diagram 600 of a memory system 620 that supports buffer management techniques for a memory system in accordance with examples as disclosed herein. The memory system 620 may be an example of aspects of a memory system as described with reference to FIGS. 1 through 5. The memory system 620, or various components thereof, may be an example of means for performing various aspects of buffer management techniques for a memory system as described herein. For example, the memory system 620 may include a storage component 625, an access component 630, an availability component 635, a linked data component 640, a threshold component 645, or any combination thereof. Each of these components, or components of subcomponents thereof (e.g., one or more processors, one or more memories), may communicate, directly or indirectly, with one another (e.g., via one or more buses).

The storage component 625 may be configured as or otherwise support a means for storing, in a buffer, a set of data for a parallel read operation that involves concurrently reading from a first die and from a second die, the set of data including first data and second data. The access component 630 may be configured as or otherwise support a means for writing the first data to a first portion of the first die in response to writing the second data to the first portion of the first die and in response to the second die being unavailable for writing the first data, the first portion of the first die reserved for a first type of write operation associated with a first quantity of memory cell levels. In some examples, the access component 630 may be configured as or otherwise support a means for copying, in response to the first data being included in the set of data for the parallel read operation, the first data from the first portion of the first die to a second portion, of the second die, reserved for a second type of writing operation associated with a second quantity of memory cell levels.

In some examples, the availability component 635 may be configured as or otherwise support a means for determining that the second die is unavailable for writing the first data in response to determining that the second die is performing a memory maintenance operation in which valid data is copied between blocks of the second die.

In some examples, the linked data component 640 may be configured as or otherwise support a means for determining that the set of data is for the parallel read operation in accordance with one or more logical addresses associated with the first data and one or more logical addresses associated with the second data.

In some examples, the linked data component 640 may be configured as or otherwise support a means for determining that the set of data is for the parallel read operation in response to the first data being associated with a first logical address that is sequentially indexed relative to a second logical address associated with the second data.

In some examples, the linked data component 640 may be configured as or otherwise support a means for determining that the set of data is for the parallel read operation in response to the first data and the second data being associated with a same write command.

In some examples, the storage component 625 may be configured as or otherwise support a means for storing, in the buffer, third data that is included in a second set of data for a second parallel read operation that involves the first die and the second die, the second set of data including fourth data. In some examples, the storage component 625 may be configured as or otherwise support a means for storing the fourth data in the buffer after storing the third data. In some examples, the storage component 625 may be configured as or otherwise support a means for delaying, in response to the third data and the fourth data being included in the second set of data for the second parallel read operation, writing the third data from the buffer to the first die until after the fourth data is stored in the buffer.

In some examples, the threshold component 645 may be configured as or otherwise support a means for determining that a data rate of data received from a host system satisfies a threshold, where delaying writing the third data is in response to the data rate satisfying the threshold.

In some examples, the threshold component 645 may be configured as or otherwise support a means for determining whether an amount of space in the buffer available for writing satisfies a second threshold, where delaying writing the third data is in response to the amount of space satisfying the second threshold.

In some examples, the storage component 625 may be configured as or otherwise support a means for updating metadata for the third data to indicate that writing the third data is to be delayed, where delaying writing the third data is in response to updating the metadata.

In some examples, the access component 630 may be configured as or otherwise support a means for writing the third data from the buffer to the first die in response to the third data being included in the second set of data for the second parallel read operation. In some examples, the access component 630 may be configured as or otherwise support a means for writing the fourth data from the buffer to the second die in response to the fourth data being included in the second set of data for the second parallel read operation.

In some examples, the described functionality of the memory system 620, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 620, or various components thereof, may be implemented at least in part by instructions (e.g., stored in memory, non-transitory computer-readable medium) executable by such at least one processor.

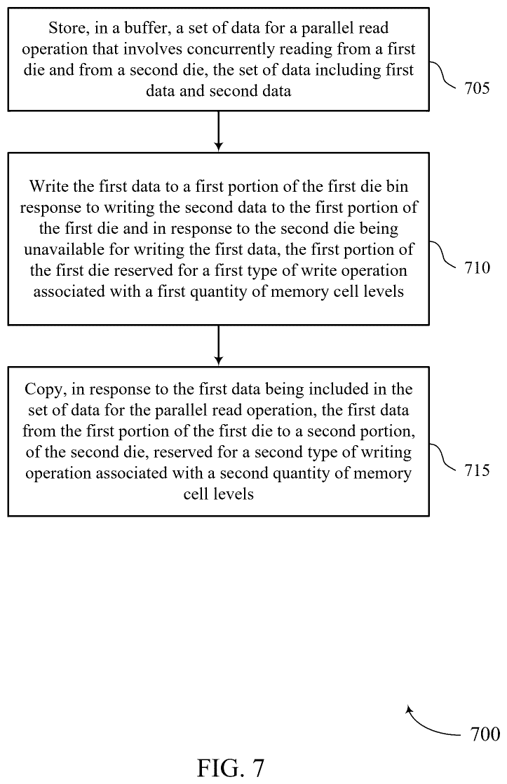

FIG. 7 shows a flowchart illustrating a method 700 that supports buffer management techniques for a memory system in accordance with examples as disclosed herein. The operations of method 700 may be implemented by a memory system or its components as described herein. For example, the operations of method 700 may be performed by a memory system as described with reference to FIGS. 1 through 6. In some examples, a memory system may execute a set of instructions to control the functional elements of the device to perform the described functions. Additionally, or alternatively, the memory system may perform aspects of the described functions using special-purpose hardware.

At 705, the method may include storing, in a buffer, a set of data for a parallel read operation that involves concurrently reading from a first die and from a second die, the set of data including first data and second data. In some examples, aspects of the operations of 705 may be performed by a storage component 625 as described with reference to FIG. 6.

At 710, the method may include writing the first data to a first portion of the first die in response to writing the second data to the first portion of the first die and in response to the second die being unavailable for writing the first data, the first portion of the first die reserved for a first type of write operation associated with a first quantity of memory cell levels. In some examples, aspects of the operations of 710 may be performed by an access component 630 as described with reference to FIG. 6.

At 715, the method may include copying, in response to the first data being included in the set of data for the parallel read operation, the first data from the first portion of the first die to a second portion, of the second die, reserved for a second type of writing operation associated with a second quantity of memory cell levels. In some examples, aspects of the operations of 715 may be performed by an access component 630 as described with reference to FIG. 6.

In some examples, an apparatus as described herein may perform a method or methods, such as the method 700. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for storing, in a buffer, a set of data for a parallel read operation that involves concurrently reading from a first die and from a second die, the set of data including first data and second data; writing the first data to a first portion of the first die in response to writing the second data to the first portion of the first die and in response to the second die being unavailable for writing the first data, the first portion of the first die reserved for a first type of write operation associated with a first quantity of memory cell levels; and copying, in response to the first data being included in the set of data for the parallel read operation, the first data from the first portion of the first die to a second portion, of the second die, reserved for a second type of writing operation associated with a second quantity of memory cell levels.

Aspect 2: The method, apparatus, or non-transitory computer-readable medium of aspect 1, further including operations, features, circuitry, logic, means, or instructions, or any combination thereof for determining that the second die is unavailable for writing the first data in response to determining that the second die is performing a memory maintenance operation in which valid data is copied between blocks of the second die.

Aspect 3: The method, apparatus, or non-transitory computer-readable medium of any of aspects 1 through 2, further including operations, features, circuitry, logic, means, or instructions, or any combination thereof for determining that the set of data is for the parallel read operation in accordance with one or more logical addresses associated with the first data and one or more logical addresses associated with the second data.

Aspect 4: The method, apparatus, or non-transitory computer-readable medium of any of aspects 1 through 3, further including operations, features, circuitry, logic, means, or instructions, or any combination thereof for determining that the set of data is for the parallel read operation in response to the first data being associated with a first logical address that is sequentially indexed relative to a second logical address associated with the second data.

Aspect 5: The method, apparatus, or non-transitory computer-readable medium of any of aspects 1 through 4, further including operations, features, circuitry, logic, means, or instructions, or any combination thereof for determining that the set of data is for the parallel read operation in response to the first data and the second data being associated with a same write command.

Aspect 6: The method, apparatus, or non-transitory computer-readable medium of any of aspects 1 through 5, further including operations, features, circuitry, logic, means, or instructions, or any combination thereof for storing, in the buffer, third data that is included in a second set of data for a second parallel read operation that involves the first die and the second die, the second set of data including fourth data; storing the fourth data in the buffer after storing the third data; and delaying, in response to the third data and the fourth data being included in the second set of data for the second parallel read operation, writing the third data from the buffer to the first die until after the fourth data is stored in the buffer.

Aspect 7: The method, apparatus, or non-transitory computer-readable medium of aspect 6, further including operations, features, circuitry, logic, means, or instructions, or any combination thereof for determining that a data rate of data received from a host system satisfies a threshold, where delaying writing the third data is in response to the data rate satisfying the threshold.

Aspect 8: The method, apparatus, or non-transitory computer-readable medium of aspect 7, further including operations, features, circuitry, logic, means, or instructions, or any combination thereof for determining whether an amount of space in the buffer available for writing satisfies a second threshold, where delaying writing the third data is bin response to the amount of space satisfying the second threshold.

Aspect 9: The method, apparatus, or non-transitory computer-readable medium of any of aspects 6 through 8, further including operations, features, circuitry, logic, means, or instructions, or any combination thereof for updating metadata for the third data to indicate that writing the third data is to be delayed, where delaying writing the third data is in response to updating the metadata.

Aspect 10: The method, apparatus, or non-transitory computer-readable medium of any of aspects 6 through 9, further including operations, features, circuitry, logic, means, or instructions, or any combination thereof for writing the third data from the buffer to the first die in response to the third data being included in the second set of data for the second parallel read operation and writing the fourth data from the buffer to the second die in response to the fourth data being included in the second set of data for the second parallel read operation.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

As used herein, the term “substantially” means that the modified characteristic (e.g., a verb or adjective modified by the term substantially) need not be absolute but is close enough to achieve the advantages of the characteristic.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” or “responsive to” may refer to one condition or action occurring at least partially, if not fully, as a result of a previous condition or action. For example, a first condition or action may be performed, and a second condition or action may at least partially occur as a result of the previous condition or action occurring (whether directly after or after one or more other intermediate conditions or actions occurring after the first condition or action).

Additionally, the terms “directly in response to” or “in direct response to” may refer to one condition or action occurring as a direct result of a previous condition or action. In some examples, a first condition or action may be performed, and a second condition or action may occur directly as a result of the previous condition or action occurring independent of whether other conditions or actions occur. In some examples, a first condition or action may be performed, and a second condition or action may occur directly as a result of the previous condition or action occurring, such that no other intermediate conditions or actions occur between the earlier condition or action and the second condition or action or a limited quantity of one or more intermediate steps or actions occur between the earlier condition or action and the second condition or action. Any condition or action described herein as being performed “based on,” “based at least in part on,” or “in response to” some other step, action, event, or condition may additionally, or alternatively (e.g., in an alternative example), be performed “in direct response to” or “directly in response to” such other condition or action unless otherwise specified.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processing system (e.g., one or more processors, one or more controllers, control circuitry, processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus, comprising:
one or more memory devices; and
processing circuitry coupled with the one or more memory devices and configured to cause the apparatus to:
store, in a buffer, a set of data for a parallel read operation that involves concurrently reading from a first die and from a second die, the set of data comprising first data and second data;
write the first data to a first portion of the first die in response to writing the second data to the first portion of the first die and in response to the second die being unavailable for writing the first data, the first portion of the first die reserved for a first type of write operation associated with a first quantity of memory cell levels; and
copying, in response to the first data being included in the set of data for the parallel read operation, the first data from the first portion of the first die to a second portion, of the second die, reserved for a second type of writing operation associated with a second quantity of memory cell levels.

2. The apparatus of claim 1, wherein the processing circuitry is further configured to cause the apparatus to:
determine that the second die is unavailable for writing the first data in response to determining that the second die is performing a memory maintenance operation in which valid data is copied between blocks of the second die.

3. The apparatus of claim 1, wherein the processing circuitry is further configured to cause the apparatus to:
determine that the set of data is for the parallel read operation in accordance with one or more logical addresses associated with the first data and one or more logical addresses associated with the second data.

4. The apparatus of claim 1, wherein the processing circuitry is further configured to cause the apparatus to:
determine that the set of data is for the parallel read operation in response to the first data being associated with a first logical address that is sequentially indexed relative to a second logical address associated with the second data.

5. The apparatus of claim 1, wherein the processing circuitry is further configured to cause the apparatus to:
determine that the set of data is for the parallel read operation in response to the first data and the second data being associated with a same write command.

6. The apparatus of claim 1, wherein the processing circuitry is further configured to cause the apparatus to:
store, in the buffer, third data that is included in a second set of data for a second parallel read operation that involves the first die and the second die, the second set of data comprising fourth data;
store the fourth data in the buffer after storing the third data; and
delaying, in response to the third data and the fourth data being included in the second set of data for the second parallel read operation, writing the third data from the buffer to the first die until after the fourth data is stored in the buffer.

7. The apparatus of claim 6, wherein the processing circuitry is further configured to cause the apparatus to:
determine whether a data rate of data received from a host system satisfies a threshold, wherein delaying writing the third data is in response to the data rate satisfying the threshold.

8. The apparatus of claim 7, wherein the processing circuitry is further configured to cause the apparatus to:
determine whether an amount of space in the buffer available for writing satisfies a second threshold, wherein delaying writing the third data is in response to the amount of space satisfying the second threshold.

9. The apparatus of claim 6, wherein the processing circuitry is further configured to cause the apparatus to:
update metadata for the third data to indicate that writing the third data is to be delayed, wherein delaying writing the third data is in response to updating the metadata.

10. The apparatus of claim 6, wherein the processing circuitry is further configured to cause the apparatus to:
write the third data from the buffer to the first die in response to the third data being included in the second set of data for the second parallel read operation; and
write the fourth data from the buffer to the second die in response to the fourth data being included in the second set of data for the second parallel read operation.

11. A method, comprising:
storing, in a buffer, a set of data for a parallel read operation that involves concurrently reading from a first die and from a second die, the set of data comprising first data and second data;
writing the first data to a first portion of the first die in response to writing the second data to the first portion of the first die and in response to the second die being unavailable for writing the first data, the first portion of the first die reserved for a first type of write operation associated with a first quantity of memory cell levels; and
copying, in response to the first data being included in the set of data for the parallel read operation, the first data from the first portion of the first die to a second portion, of the second die, reserved for a second type of writing operation associated with a second quantity of memory cell levels.

12. The method of claim 11, further comprising:
determining that the second die is unavailable for writing the first data in response to determining that the second die is performing a memory maintenance operation in which valid data is copied between blocks of the second die.

13. The method of claim 11, further comprising:
determining that the set of data is for the parallel read operation in accordance with one or more logical addresses associated with the first data and one or more logical addresses associated with the second data.

14. The method of claim 11, further comprising:
determining that the set of data is for the parallel read operation in response to the first data being associated with a first logical address that is sequentially indexed relative to a second logical address associated with the second data.

15. The method of claim 11, further comprising:
determining that the set of data is for the parallel read operation in response to the first data and the second data being associated with a same write command.

16. The method of claim 11, further comprising:
storing, in the buffer, third data that is included in a second set of data for a second parallel read operation that involves the first die and the second die, the second set of data comprising fourth data;
storing the fourth data in the buffer after storing the third data; and
delaying, in response to the third data and the fourth data being included in the second set of data for the second parallel read operation, writing the third data from the buffer to the first die until after the fourth data is stored in the buffer.

17. The method of claim 16, further comprising:
determining whether a data rate of data received from a host system satisfies a threshold, wherein delaying writing the third data is in response to the data rate satisfying the threshold.

18. The method of claim 17, further comprising:
determining whether an amount of space in the buffer available for writing satisfies a second threshold, wherein delaying writing the third data is in response to the amount of space satisfying the second threshold.

19. The method of claim 16, further comprising:
updating metadata for the third data to indicate that writing the third data is to be delayed, wherein delaying writing the third data is in response to updating the metadata.

20. The method of claim 16, further comprising:
writing the third data from the buffer to the first die in response to the third data being included in the second set of data for the second parallel read operation; and
writing the fourth data from the buffer to the second die in response to the fourth data being included in the second set of data for the second parallel read operation.

21. A non-transitory computer-readable medium storing code comprising instructions which, when executed by one or more processors of an apparatus, cause the apparatus to:
store, in a buffer, a set of data for a parallel read operation that involves concurrently reading from a first die and from a second die, the set of data comprising first data and second data;
write the first data to a first portion of the first die in response to writing the second data to the first portion of the first die and in response to the second die being unavailable for writing the first data, the first portion of the first die reserved for a first type of write operation associated with a first quantity of memory cell levels; and
copying, in response to the first data being included in the set of data for the parallel read operation, the first data from the first portion of the first die to a second portion, of the second die, reserved for a second type of writing operation associated with a second quantity of memory cell levels.

22. The non-transitory computer-readable medium of claim 21, wherein the instructions, when executed by the one or more processors of the apparatus, cause the apparatus to:
determine that the second die is unavailable for writing the first data in response to determining that the second die is performing a memory maintenance operation in which valid data is copied between blocks of the second die.

23. The non-transitory computer-readable medium of claim 21, wherein the instructions, when executed by the one or more processors of the apparatus, cause the apparatus to:
determine that the set of data is for the parallel read operation in accordance with one or more logical addresses associated with the first data and one or more logical addresses associated with the second data.

24. The non-transitory computer-readable medium of claim 21, wherein the instructions, when executed by the one or more processors of the apparatus, cause the apparatus to:
determine that the set of data is for the parallel read operation in response to the first data being associated with a first logical address that is sequentially indexed relative to a second logical address associated with the second data.

25. The non-transitory computer-readable medium of claim 21, wherein the instructions, when executed by the one or more processors of the apparatus, cause the apparatus to:
determine that the set of data is for the parallel read operation in response to the first data and the second data being associated with a same write command.
